(19) United States
(12) Patent Application Publication
(10) Pub. No.: US 2016/0300303 A1
(43) Pub. Date: Oct. 13, 2016

(54) Computer Based Trading System and Methodology For Identifying Trading Opportunities

(71) Applicant: Newport Exchange Holdings, Inc., Irvine, CA (US)

(72) Inventors: Samuel Seiden, Glenview, IL (US); Steven Albin, Irvine, CA (US); Jose Antonio Blasco Momparler, Valencia (ES)

(21) Appl. No.: 14/681,171

(22) Filed: Apr. 8, 2015

(51) Int. Cl. G06Q 40/04

(52) U.S. Cl. CPC G06Q 40/04

(57) ABSTRACT

The system and methodology of the present invention operate to generate trading signals based on identifying various trading patterns referred to as setups. When these setups are detected, and depending on the specific setup detected, a supply zone or demand zone is next generated which indicates the price range for the instrument in which a sell or buy trade signal may be issued. When the underlying instrument trades within this range, and under other appropriate conditions, the potential trade is identified as a trading opportunity to be communicated to one or more users of the system. The system and methodology of the present invention further operates to permit a user and/or system administrator to apply various filters and other selections to limit the possible actionable trades presented to the user in various ways. The system is also preferably configured to notify users of potential actionable trades via any number of methodologies such as web-based presentation, emails, texts and other communications protocols.

### RELATED SUBJECT MATTER

The subject matter of the present patent application is related to the subject matter contained in U.S. Pat. No. 8,650,115, issued on Feb. 11, 2014 to the same assignee as the assignee of the present application. The subject matter of U.S. Pat. No. 8,650,115 is expressly incorporated herein.

### FIELD OF THE INVENTION

The present invention is directed generally to systems and methodologies for effectively trading securities and other liquid instruments, and, more particularly to systems and methodologies which are designed to provide traders with current indicators for the purchase and sale of such securities and other instruments at profitable pricing levels.

### BACKGROUND OF THE INVENTION

While there is some variance depending upon the state of the economy and market conditions in general, the volume of securities traded on various worldwide markets and exchanges is exceedingly large and getting larger. Securities in this context can be any of a number of financial instruments such as stocks, bonds, mortgage backed securities, options, or, alternatively, hard assets such as precious metals, commodities and the like. The common element among these widely traded vehicles (hereinafter collectively referred to as “securities” for ease of reference), however, is that they enjoy a great deal of liquidity and the markets in which they trade are well established with many different buyers and sellers who participate in buying and selling the applicable security.

When there are a large number of buyers and sellers, the market for that security tends to be more active and perhaps more importantly, the spread between the available purchase price (the “ask”) and the available selling price (the “bid”) tends to be narrower. This in turn encourages buyers and sellers to participate in the buying and selling of that security since they are less likely to overpay or sell for too low of a price solely because of the “transaction cost” associated with the buy/sell spread which is incurred in executing the buy or sell transaction. Additionally, markets for securities tend to be more active where commissions and/or other fees and charges associated with the purchase and sale transaction are lower since the collective costs incurred from such costs and the bid/ask spread directly impact the profitability of trading that security.

In addition to minimizing transaction costs, profitable trading necessarily involves the need to purchase securities at a lower cost than the price at which the security is ultimately sold. Or, in the case of short selling, it is necessary to first sell the security at a higher cost than the price at which the security is ultimately covered. There are various known techniques, systems and methodologies for attempting to do just this. For example, some traders (typically individuals or “retail” traders as opposed to professional or “institutional” traders) will trade manually, largely based on nothing more than a gut feel. Alternatively, various individuals and even sophisticated individuals and institutional traders will use manual “systems” under which they devise a plan to make specific trades under various circumstances and market conditions. For example, such a trading plan may be as simple as buying XYZ stock when it sells for a price of $40 or lower (ask at $40 or below) and selling that same stock which it sells for a price of $44 or above (bid at $44 or above).

The foregoing plan may be implemented as a simple trading policy that a trader manually follows by entering appropriate buy and sell orders at the appropriate times. Or, the trader may utilize an online broker that provides the functionality for the trader to enter standing orders to make these trades when the specified market conditions are met. As yet another example, the trader may employ a software based tool that interacts and communicates with his or her brokerage trading platform to execute trades consistent with trading system rules. Other applications and services are also available which offer traders the ability to implement their own trading plan and/or plans and strategies developed by third parties.

The trading plan described above is generally considered to fall within the class of trading methodologies referred to as “technical analysis”. In this class of trading methodologies, specific decisions are made based solely on historic price movement for the underlying security as well as expected future price movement based on mathematical analysis tied to price/time chart movements. Technical analysis techniques for predicting and acting upon expected future price movement are in widespread use by retail and institutional traders.

This class of techniques and the systems that implement them, however, do suffer from a number of drawbacks. For example, in many cases, a great many competing traders are using the same systems with the same predictive algorithms and are acting upon these predictions generated by these systems at the same time. At a market based level, this produces undesirable outcomes for these traders since they are competing at the same time to buy a security with others using the same algorithms based on the same predictions at the same time. Further, they are also competing against each other when the system indicates that the trader should sell a security. In both of these cases, an artificial demand (buy signal) or supply (sell signal) is created which tends to move the price up or down, respectively beyond what it would otherwise be and thus resulting, in theory, in a less profitable trade for each of the traders using the same system.

Another disadvantage of technical analysis is that, by definition, it is based on price movement that has occurred in the past and this information is used to predict price movement for the future. Unfortunately, it is theorized that price movement is largely random and instead driven only by supply and demand which exists in real time as opposed to what has happened in the past. The net result of this is that technical analysis tools, while they can be useful, are often times not the ideal predictor of future price movement.

Another class of trading techniques which are in use are those known as “fundamental analysis”. This class of techniques relies on examining the fundamental properties of the asset underlying the security. For example, for a common stock associated with a company, trading decisions may be based on earnings, revenue and/or newsworthy events about that company's positioning within its industry. A practically unlimited number of other metrics may be used as well. More common examples include price to earnings ratios, level of debt, earnings growth, deals expected to add to revenue in the future, etc. In the case of securities which represent ownership in hard assets such as gold, oil, etc., trading decisions using fundamental analysis might include such metrics as predicted demand for the underlying asset, predicted supply, newsworthy stories regarding the applicable asset such as new oil wells being drilled, disruptions in the supply chain for bringing the asset to the end user, etc.

While fundamental analysis based decisions and the systems that implement them also have their place in trading, they also suffer from drawbacks. For example, notwithstanding a very good understanding of a company and its financial picture, the market for stock representing ownership in that company may depart from the realities of the value of that company. This is evidenced by the fact that all stocks do not, for example, trade at the same multiple of earnings. There are other factors that go into the real time price for a stock that can not be addressed by fundamental analysis. Examples include “buzz” about certain companies and industries, rumors concerning that company, and other intangible aspects of the value of a particular stock that can not be measured or predicted using known fundamental analysis techniques.

There exist a number a software tools for trading securities and other assets whereby one or more trading strategies are applied and a user is presented with one or more possible trades (typically a buy, sell, sell short or cover signal) that may be timely based upon market conditions and the specific trading strategy applied. Unfortunately various drawbacks exist with these tools. In some cases, these tools do not function on a real time or even on a timely basis such that by the time the potential trades are presented, they may no longer be good trades or trades that otherwise comply with the rules of the applicable trading system. In other cases, these tools do not present all available trades in a manner that is easily understood or actionable by a user.

There also exist other drawbacks with these systems. Some of these systems may simply present trades that are generated by applying the rules of the trading system(s) but which are not specifically tailored for the user based on the user's risk tolerance, available capital, current positions, personal strategy and/or whether the user is seeking current income, medium term results or a strategy designed to generate long term wealth.

### SUMMARY OF THE INVENTION

It is thus a primary object of the invention to provide a system and methodology that addresses the shortcomings of the prior art as discussed above.

It is another object of the present invention to provide a system and methodology which provides traders with current indicators designed to achieve improved trading results when trading a wide variety of securities, commodities and any other instrument which provides at least a reasonable degree of liquidity.

It is a further object of the present invention to provide a system and methodology which employs the realities of supply and demand in markets to provide enhanced predictions on price movement which in turn is designed to generate more profitable trading results.

It is a still further object of the present invention to provide a computer based trading system which generates recommended trading actions based upon the real time status of supply and demand for one or more securities or other tradable instruments.

It is a yet further object of the present invention to provide a computer based trading system for trading stocks based upon the real time status of the supply and demand for a particular stock.

It is another object of the present invention to provide a computer based trading system for trading commodities based upon the real time status of the supply and demand for a particular commodity.

It is a further object of the present invention to provide a computer based trading system for trading currencies based upon the real time status of the supply and demand for a particular currency.

It is a yet further object of the present invention to provide a computer based trading system that identifies one or more price over time patterns and, using known characteristics associated with market supply and demand, generating trading signals based thereupon.

It is a still further object of the present invention to provide a computer based trading system that applies one or more known trading systems to a defined universe of tradeable instruments to generate a listing of possible trading actions available to a user on a timely basis.

It is a further object of the present invention to provide these possible trading actions on a timely basis as the same relates to the duration of the trading strategy such as immediate income, medium term and longer term wealth generation.

It is an even further object of the present invention to provide possible trading actions in a robust and highly configurable environment such that a user and/or system administrator can apply one or more filters to limit possible trading actions to those that meet one or more applied characteristics.

It is a still further object of the present invention to provide a list of possible trading actions that also allows a user to select one or more such possible actions and act upon such selected actions in the form of a trade execution.

It is a yet further object of the present invention to provide a computer based trading system that notifies users of possible trading actions on a timely basis via one or more methods such as email, web based notifications and/or SMS texts.

It is a still further object of the present invention to provide a computer based trading system with novel reporting and display functionality such that possible trading actions are displayed in an easily readable and organized fashion through various differing display formats.

A primary objective the invention disclosed herein is a system and methodology which effectively applies an objective set of rules that are aligned with the governing dynamics of supply and demand that works in any asset class (e.g. Stocks, Futures, Forex, Options), in any market and in any timeframe.

The system and methodology of the present invention operate to generate trading signals based on identifying various trading patterns referred to as setups. When these setups are detected, and depending on the specific setup detected, a supply zone or demand zone is next generated which indicates the price range for the instrument in which a sell or buy trade signal should be issued. When the underlying instrument trades within this range, and under other appropriate conditions, the potential trade is identified as a possible actionable trade to be communicated to one or more users of the system.

The system and methodology of the present invention further operates to permit a user and/or system administrator to apply various filters and other selections to limit the possible actionable trades presented to the user in various ways. Examples include limiting the universe of tradable instruments considered, limiting to types of instruments such as stocks, bonds, options, etc., and limiting by other characteristics such as minimum instrument trading volume, stock industry, price range and other characteristics. The system is also preferably configured to notify users of potential actionable trades via any number of methodologies such as web-based presentation, emails, texts and other communications protocols.

The system may also permit a user to act on one or more desired trades through the interface presentation, by, for example, clicking on a displayed link. The system may also be configured by a user so as to cause the system to behave in a way that is customized for the user independent of the specific trading strategies applied. For example, the user may configure the system to provide notifications of actionable trades on a desired frequency such as real time, at market open and/or at various points during a trading day for the instrument. Further, the system and methodology of the present invention may permit a user to customize the results generated to other user-specific characteristics such as the user's desired trading timeframe (e.g. short term trades, medium term trades, long-term trades), the user's available trading capital and/or the user's specific risk tolerance.

### BRIEF DESCRIPTION OF THE DRAWINGS

FIG. 1 is a diagram depicting the major components of the system of the present invention including the trading opportunity presentation system (TOPS) of the present invention in a preferred embodiment thereof;

FIG. 1A is diagram depicting the major components of the supply and demand sub-system of the present invention in a preferred embodiment thereof;

FIG. 2 is a diagram illustrating the supply and demand relationship for an exemplary stock in an exemplary market in which that stock is traded;

FIG. 3 is a diagram illustrating price movement for an underlying instrument in which market conditions reflect supply exceeding demand;

FIG. 4 is a diagram illustrating price movement for an underlying instrument in which market conditions reflect demand exceeding supply;

FIG. 5 is a diagram illustrating the drop-base-rally setup of the present invention in a preferred embodiment thereof as well as action to be taken when such a setup is identified;

FIG. 6 is a diagram illustrating the rally-base-drop setup of the present invention in a preferred embodiment thereof as well as action to be taken when such a setup is identified;

FIG. 7 is a diagram illustrating the supply and demand zones of the present invention in a preferred embodiment including the proximal and distal lines associated therewith;

FIG. 8 is a diagram illustrating an exemplary drop-base-rally setup and an exemplary resulting demand zone which is created as a result thereof;

FIG. 9 is a diagram illustrating various options in constructing demand zones according to the present invention in a preferred embodiment thereof;

FIG. 10 is a diagram illustrating an exemplary rally-base-drop-setup and an exemplary resulting demand zone which is created as a result thereof;

FIG. 11 is a diagram illustrating various options in constructing supply zones according to the present invention in a preferred embodiment thereof;

FIG. 12 is an exemplary screenshot illustrating one possible user interface whereby a system user may view and access potential trading opportunities as generated by the system;

FIG. 13 is an exemplary screenshot illustrating a possible user interface whereby a system user may view and access potential trading opportunities as generated by the system as well as the connection of a proposed trade to a trading setup;

FIG. 14 is an exemplary screenshot illustrating another possible user interface whereby a system user may view and access potential trading opportunities as generated by the system; and

FIG. 15 is a flowchart illustrating the steps associated with the process of the present invention as may be executed by the system of the present invention in a preferred embodiment thereof.

### DETAILED DESCRIPTION OF THE INVENTION

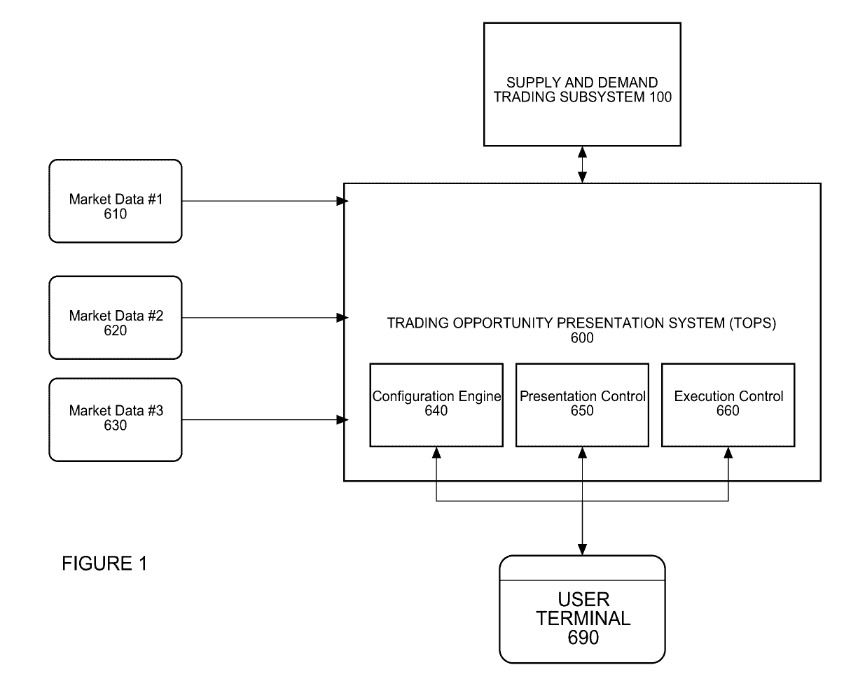

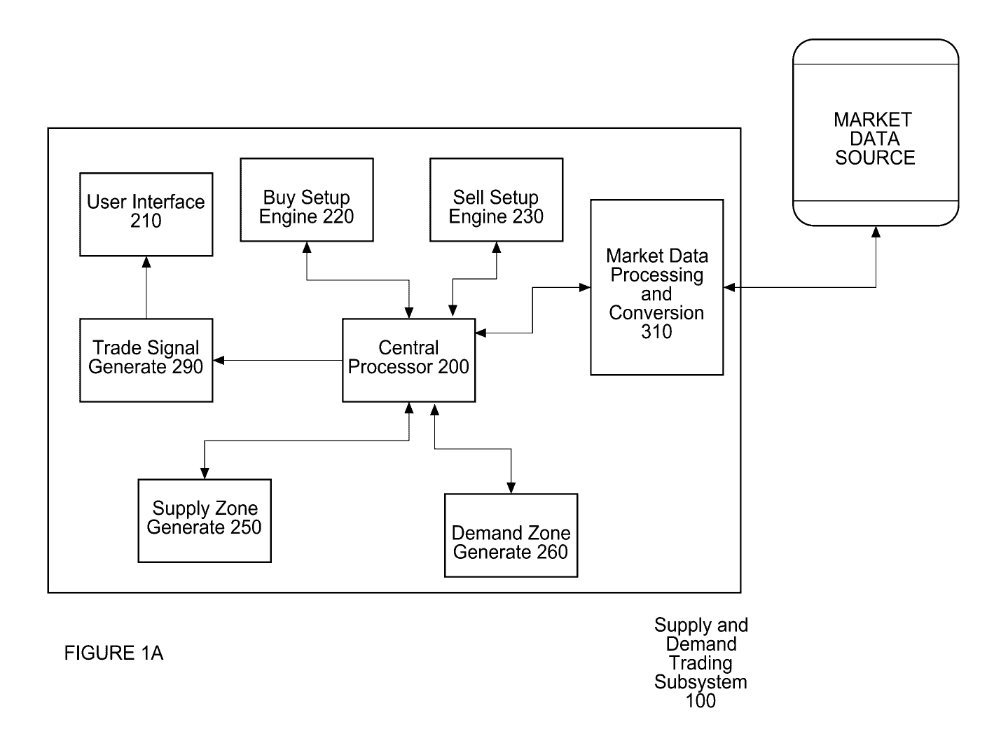

With reference now to FIG. 1, the system of the present invention, in a preferred embodiment thereof, is now described. Trading Opportunity Presentation System (TOPS) 600 is preferably a computer based system for implementing the functionality of the present invention as described in greater detail below. While an exemplary architecture is described, it will readily be understood by one of skill in the art, that an unlimited number of architectures and computing environments are possible while still remaining within the scope and spirit of the present invention.

TOPS 600 and Supply and Demand Trading Subsystem 100 may operate on one or more servers and may communicate with each other through electronic communication links. The servers may include electronic storage, one or more processors, and/or other components. The servers may also include communication lines, or ports to enable the exchange of information with a network and/or other computing platforms. The servers may include a plurality of hardware, software, and/or firmware components operating together to provide the functionality attributed herein to TOPS 600 and Supply and Demand Trading Subsystem 100.

Electronic storage associated with the servers may comprise non-transitory storage media that electronically stores information. The electronic storage media of electronic storage may include one or both of system storage that is provided integrally (i.e., substantially non-removable) with servers and/or removable storage that is removably connectable to the servers via, for example, a port or a drive.

Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from servers, information received from user terminals 690, and/or other information that enables the servers to function as described herein.

Supply and Demand Trading Subsystem 100 generates potential trades according to a supply and demand based process as further described below in connection with FIG. 1A. Supply and Demand Trading Subsystem 100 communicates with TOPS 600 so that TOPS 600 can request and receive potential trades as well as issue various commands and provide selections and other data to Supply and Demand Trading Subsystem 100. Each of Supply and Demand Trading Subsystem 100 and TOPS 600 may comprise one or more modules, software programs and/or processes running on one or more computers such as servers, desktop or laptop computers, handheld devices or any other computing platform or hardware device.

TOPS 600 further has access to one or more market data sources. These are illustrated in FIG. 1 as Market Data #1 (610), Market Data #2 (620) and Market Data #3 (630). However, there may be more or less sources of market data available to TOPS 600. Further, communication with market data sources may be one way (periodic transmission of market data from the applicable source to TOPS 600) or two way whereby TOPS 600 may periodically request market data from one or more market data sources and/or periodically receive market data without making a specific request.

Market data sources (610, 620 and 630) may be any source of market data respecting one or more categories of tradable instruments for which TOPS 600 may generate and display potential trades. For example, market data sources may comprise real time and/or near-real time feeds for stocks, bonds, currencies, commodities and other tradable instruments. These market data sources preferably provide data on a real time basis during active trading of the applicable instruments although, in some cases, data less frequent than real time data may be used particularly in the case of trades being generated for medium and longer term strategies. In one embodiment of the present invention, market data sources may be obtained through commercial services such as Tradestation™ and/or other platforms through which such data may be obtained.

TOPS 600 may be accessed through one or more user terminals 690. Although only one user terminal 690 is shown in FIG. 1, in typical practice, multiple user terminals will be accessed by multiple users/subscribers to access the information made available to users by TOPS 600. These user terminals 690 may be one of various computing platforms such as PC's, laptops, smartphones, tablets and/or other fixed or mobile devices through which a user may interact with TOPS 600. Preferably, user terminals 690 include a display screen and an input means such as a keyboard and/or a pointing device such as a mouse. User terminals 690 may communicate with TOPS via various known communications links and protocols such as through the internet, VPN as well as other public and private networks.

The primary components of TOPS 600 are now described at a high level with further details and examples provided elsewhere in this specification. These components may, in one embodiment, include configuration engine 640, presentation control 650 and execution control 660. Again, these components preferably comprise one or more software modules running on a computer platform such as a server based system.

At a high level, configuration engine 640 receives and processes commands from users via user terminals 690 regarding specific configurations desired by users in connection with potential trades provided to users. For example, users may interact with configuration engine 640 in order to specify one or more filters desired to limit potential trades provided. This might include only trades relating to stock instruments, only trades relating to specific stocks, only trades relating to stocks with specific trading values as well as almost any other criteria that might be available through TOPS 600. In addition to or alternatively to users/subscribers, filters and other configuration selections may be made and selected by administrators working on behalf of a company operating TOPS 600 potentially as a service to users. These administrators may access configuration engine 640 and make configuration selections via terminals similar to user terminals 690 or other devices which permit interaction with TOPS 600 generally and configuration engine 640 more specifically. More detail on filters, selections and configuration of the system generally and by individual users is provided below.

Presentation control 650 may be another software module operating as a component of TOPS 600. Again, at a high level, presentation control component 650 operates to control the specific data and form of display presented to user in connection with potential trades which may be available to a user as may be displayed on user terminal 690. Presentation control 650, as directed by a user or an administrator, or both, may display information in the form of a chart, a graph, some combination and/or other forms of data display which is desirable by a user in order to efficiently and effectively present a set of available trades that may be available in a given time frame based on specified criteria.

Presentation control 650, may, in a preferred embodiment, also operate to control the vehicle by which a user may obtain trading information at user terminal 690. For example, and as more fully described below, presentation control, as directed by users and/or administrators, may alert users to potential trades via a web based display, an email notification, an SMS text, an automated phone call and/or other methodologies as may be selected by users and administrators. More detail regarding types of notifications and related presentation is provided below.

Execution control component 660 may be included in TOPS 660 as an additional module to permit users to select and act upon one or more potential trades made available to user by TOPS 600. Thus, for example, a user may be presented at user terminal 690 with ten potential trades satisfying the user's criteria as specified via interaction with configuration engine 640 as well as meeting the primary criteria of the trading system implemented by Supply and Demand Trading Subsystem 100. A user may select one of these trades for execution through interaction with execution control component 660. Although not shown in FIG. 1, execution of any such trades would require interaction with and communication of selected trade information to a trading platform and/or directly to an exchange so that selected trades may be executed.

Now that a high level description of TOPS 600 has been provided, the specific aspects of the novel trading methodologies implemented by Supply and Demand Trading Subsystem 100 are discussed. Following that description, the discussion then continues with the novel aspects of TOPS 600 including the “market screener” aspects of the system using and leveraging the trading opportunities generated by Supply and Demand Trading Subsystem 100 including various examples of screening capabilities, novel approaches for presenting the potential trades to users including ways in which both the system approach required by the methodologies of Supply and Demand Trading Subsystem 100 and the unique selection criteria of users can be combined to identify, display and select preferred trading opportunities uniquely tailored to each of the users. For example, during any specific time window and from the universe of potential trades generated using the novel supply and demand trading strategies implemented by Supply and Demand Trading Subsystem 100, additional user criteria may be applied to tailor presented trading opportunities further to a user's desires including those reflecting risk tolerance, investment horizon, category of tradable instruments as well as other selection criteria.

With reference now to FIG. 1A, the major components of Supply and Demand Trading Subsystem 100 are now described. Supply and Demand Trading Subsystem 100 is preferably implemented on a general purpose computing platform such as a server computer which has sufficient processing power and input/output capabilities to support multiple sessions with multiple users accessing Supply and Demand Trading Subsystem 100 simultaneously. At the heart of this computing platform is central processor 200 which manages and executes all processes hereinafter described. User interface 210 serves to provide the interface between Supply and Demand Trading Subsystem 100 and user terminals such as user terminal 690 in FIG. 1 (not shown in FIG. 1A) to the extent that users may directly interact with Supply and Demand Trading Subsystem 100 as an alternative to though other components of TOPS 600. This may include formatting data for transmission and display by user terminals 690 as well as receiving data from terminals 690 and formatting and/or converting such data in a manner such that it is usable by Supply and Demand Trading Subsystem 100.

Trade signal generation functionality 290 represents a set of processes which collectively generate trading signals such as buy and sell signals which result from the execution of algorithms and processes which are resident within Supply and Demand Trading Subsystem 100, such algorithms and processes being described in detail below. Trade signals are generated by trade signal generation functionality 290 as and when commanded by central processor 200 and such signals are communicated to TOPS 600. So, for example, if a signal to buy a specific stock results from one of the processes resident within Supply and Demand Trading Subsystem 100, central processor 200 ensures that that signal is generated by trade signal generator 290 and communicated to TOPS 600.

Supply and Demand Trading Subsystem 100 further preferably includes a number of functional components that execute the novel processes of the present invention which are designed to leverage information concerning supply and demand of various stocks, bonds and other vehicles which can be readily traded, to obtain profitable trading results. One of these components is buy setup engine 220 which employs the novel methodologies of the present invention to determine the price levels at which a security or other tradable instrument should be bought according to preferred embodiments of the present invention which are described in detail below. Similarly, sell setup engine 230 determines the price levels at which a security or other tradable instrument should be sold according to the teachings of the present invention in a preferred embodiment thereof. Supply zone generate functionality 250, which is under the control of central processor 200, generates a price level zone (range) in which supply and demand for a particular tradable instrument are out of balance in a way that the instrument should be sold since it is believed that an imminent price movement in the downward direction is expected. Further details about how this zone is determined, created and used according to the present invention, in a preferred embodiment, are provided below. Similarly, demand zone generate functionality 260 generates a price level zone (range) at which it is believed that supply and demand are out of balance in a way that a tradable instrument should be purchased since an imminent upwards price movement is expected.

Position size engine 270, under the control of central processor 200, may be optionally included within Supply and Demand Trading Subsystem 100. Position size engine 270 serves to determine, based upon a specific trader's available capital and risk tolerance, the recommended position which should be purchased and/or sold in connection with the trading signals which are generated by Supply and Demand Trading Subsystem 100.

Market data processing and conversion functionality 310 receives market data from one or more external sources and processes and formats this information so that it can be used by the other functional components of Supply and Demand Trading Subsystem 100 such as buy setup engine 220 and sell setup engine 230. As noted above, market data may also be fed directly to TOPS 600 and Supply and Demand Trading Subsystem 100 may obtain market data in that manner and/or from market data sources shown in FIG. 1A. Examples of such data include real time market feeds associated with a great many tradable instruments of interest to and/or currently being traded by users of Supply and Demand Trading Subsystem 100. For example this market data may comprise real time streaming data of price levels associated with various stocks, bonds, commodities, currencies, etc. as such data is made available by the relevant markets as well as third party data providers. In a preferred embodiment, this data represents the most accurate and current data available with respect to the tradable instruments so that signals generated by Supply and Demand Trading Subsystem 100 are accurate, timely and actionable.

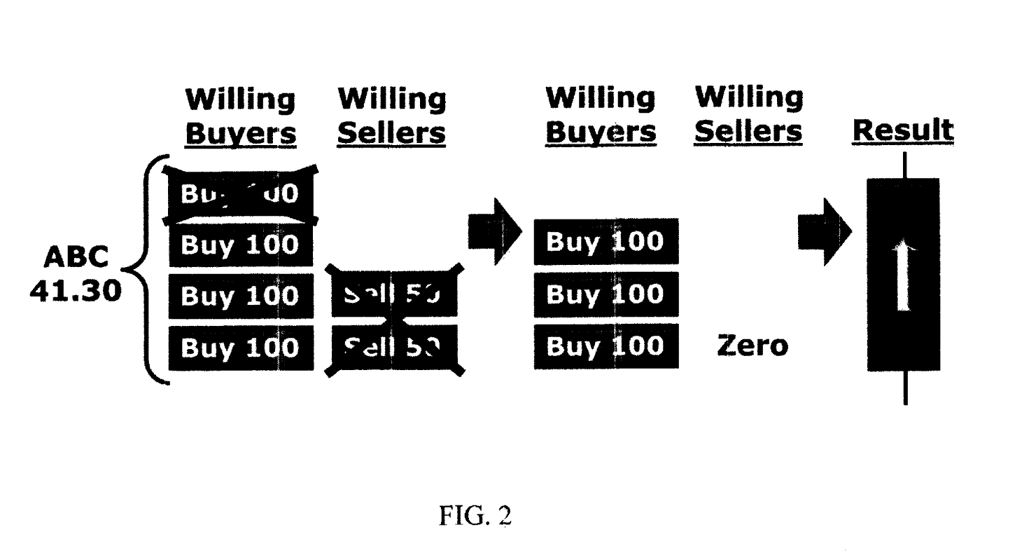

Now that the system of the present invention and its various components, in a preferred embodiment thereof, have been described, the novel teachings of the present invention with respect to the various methodologies employed to generate trading signals will now be discussed. With reference to FIG. 2, a discussion with respect to the dynamics of supply and demand is now provided as the backdrop for the many novel aspects of the present invention. In this example, the market for ABC which is currently trading at $41.30 per share is illustrated in its initial state to the left of the leftmost arrow. In this state, there are 4 different willing buyers that each seek to buy 100 shares of ABC at a price of $41.30. Further, there are 2 willing sellers that each seek to sell 50 shares of ABC at a price of $41.30. Due to this equilibrium, willing buyers and sellers that are willing to buy and sell at the same price are matched either randomly or according to one or more predetermined exchange rule(s). In this case, the buyer represented by the top rectangle purchases 100 shares which are obtained from the two willing sellers that are each willing to sell 50 shares at the agreed upon price.

Instantaneously upon completion of the above buy/sell transaction, the market for ABC at a price of $41.30 shifts to that represented to the right of the leftmost arrow. Now, there remain three buyers each willing to purchase at $41.30 but no willing sellers at this price. As a result of this instantaneous market condition, and based on supply and demand, the price at which ABC can be purchased (ask) will go up. In particular, the ask price will go up to the price at which the seller at the now lowest price is willing to sell shares of ABC. This also tends to have the effect of causing the bid price (the price at which buyers are willing to buy ABC) to go up, though this is not always the case. The increase in bid following an increase in ask due to exhaustion of available shares at a previous price may be largely due to human nature (greed) in terms of a desire to purchase the shares (demand) at a higher price notwithstanding that the price at which shares can be purchased has gone up.

In other words, each and every candle (a representation of stock price movement over time) is created as a direct result of an ongoing demand and supply relationship associated with the applicable trading instrument. Order flow with respect to that instrument is thus driven by the demand and supply for that instrument which is based on perceived value, fear and greed. Further, it is important to note that the origin of motion or change in price is an equation where one of two competing forces (buyers and sellers) becomes zero at a specific price.

In order to apply the novel teachings of the present invention to real time trading markets it is critical to determine where and when market prices for instruments turn. With respect to demand, price turns higher at a price level where willing demand exceeds willing supply. With respect to supply, price turns lower at a price level where willing supply exceeds willing demand. Since the markets for tradable instruments are almost always a zero sum game, the novel system and methodologies of the present invention operate to determine these pricing turning points and leverage the human emotions of fear and greed of other competing traders to provide optimum trading results.

The system and method of the present invention leverages knowledge of supply and demand characteristics and expected future price movements based on those characteristics to indicate the optimum times at which an instrument should be purchased or sold. These times coincide with price turning points which are identified by the system and methodologies of the present invention. And further, these turning points occur at times when supply and demand are out of balance for the particular instrument being traded. It is at this point that the system of the present invention identifies low risk, high reward, high probability entry and exit points in the markets via the generation of trading signals by trade signal generator 290 which are transmitted by Supply and Demand Trading Subsystem 100 to TOPS 600 for processing, display and/or execution as described herein.

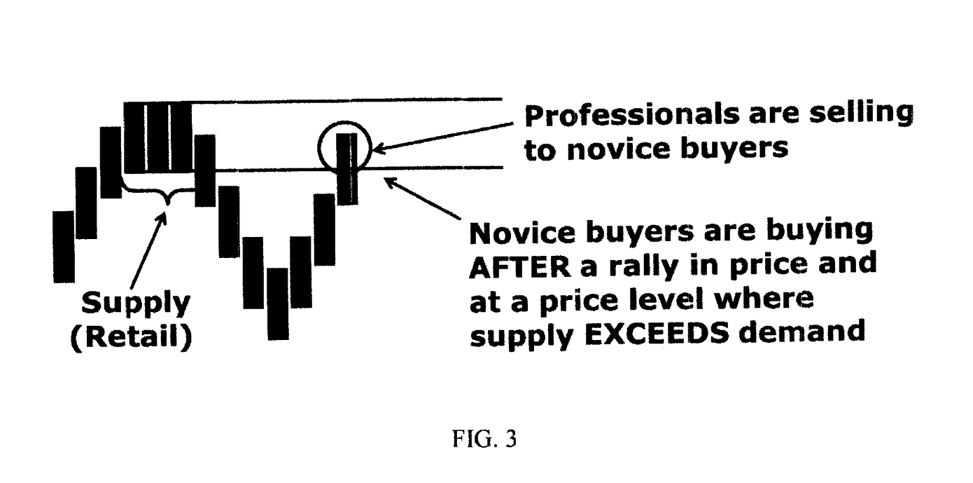

Again, operating under the assumption that trading in most markets is a zero sum game (winners win at the expense of losers losing), it is important to identify the mistakes that other traders typically make in markets so that these can be exploited by Supply and Demand Trading Subsystem 100. The first mistake often made by novice traders is buying AFTER a rally in price and the second mistake also often made is buying at a price level where supply EXCEEDS demand. These concepts are illustrated in FIG. 3. In this figure, the price points between the two horizontal lines represent a market for the instrument in which supply exceeds demand. This is often the case after a rally in the instrument as shown by the rightmost four bars. In this case, there has been a rally in price to the point that there is more supply in the market than there is demand. This is often caused by large amounts of additional supply being added by professional traders at the higher price points. Notwithstanding that this is an inopportune time to buy, many novice traders do just that having seen the rally in the instrument recently occur. As will be discussed in greater detail below, Supply and Demand Trading Subsystem 100, using market data available to it, determines where these turning points are and rather than buying in a case where supply exceeds demand, as determined by Supply and Demand Trading Subsystem 100, a signal would instead be generated to sell the instrument.

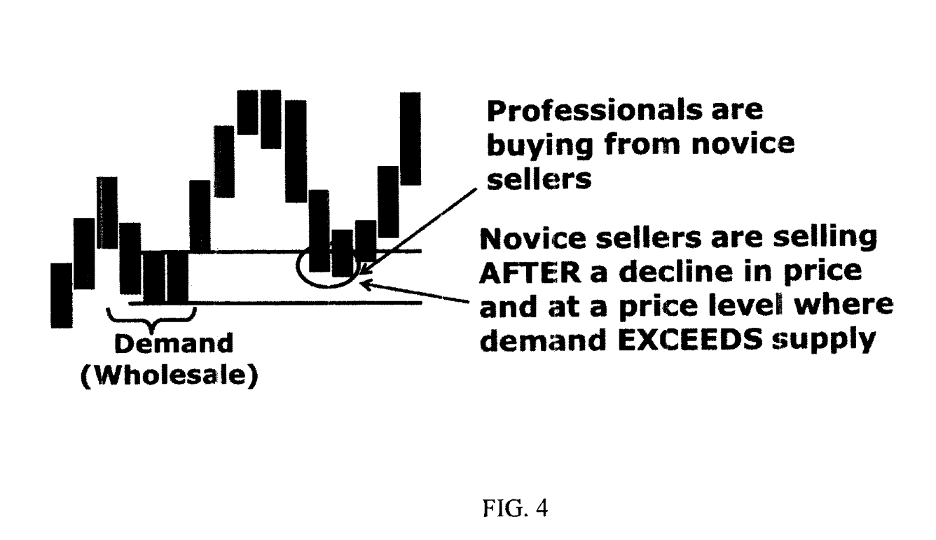

With respect to selling, there are similarly two common mistakes made by novice sellers. These are selling AFTER a decline in price and selling at a level where demand EXCEEDS supply. This is illustrated in FIG. 4. In this case, the price points between the two horizontal lines represent a market for the instrument in which demand exceeds supply. As can be seen in the figure, following three bars of steep downward price movement, the market gets to a point where demand exceeds supply. Often, novice traders will be selling at this point in time. Instead, Supply and Demand Trading Subsystem 100 identifies market conditions such as they are and generates a buy signal rather than a sell signal.

Now that the underlying premises driving the strategies implemented by Supply and Demand Trading Subsystem 100 have been described, the strategies, in a preferred embodiment thereof, will now be discussed. These strategies are largely defined by what are referred to herein as “set-ups” which are, in fact, the identification by Supply and Demand Trading Subsystem 100 of market conditions which indicate that either a buy or sell transaction in a specific instrument should be made. The first set-up is referred to as a Demand Buy set-up. In this case, market data is received by market data processing and conversion component 310 under the control of central processor 200 and buy setup engine, which is constantly analyzing such market data, has detected one of these Demand Buy set-up conditions within the market for the instrument. This in turn causes a buy signal for the instrument to be generated by trade signal generator 290 and this signal is either communicated to one or more of user terminals 690 via user interface 210 or sent directly to brokerage trading platform 50 for execution.

As discussed more fully herein, TOPS 600 may be configured by a user or administrator to limit trading opportunities to specific instruments, stocks, or though other designed criteria. Further, TOPS 600 may be configured for the generation of trading opportunities at various designed times and/or at various designated intervals. As such, and as per the present invention, TOPS 600 will preferably control Supply and Demand Trading Subsystem 100 in terms of the trading opportunities analyzed and the frequency and timing of providing those opportunities to TOPS 600 for ultimate viewing and selection by a user.

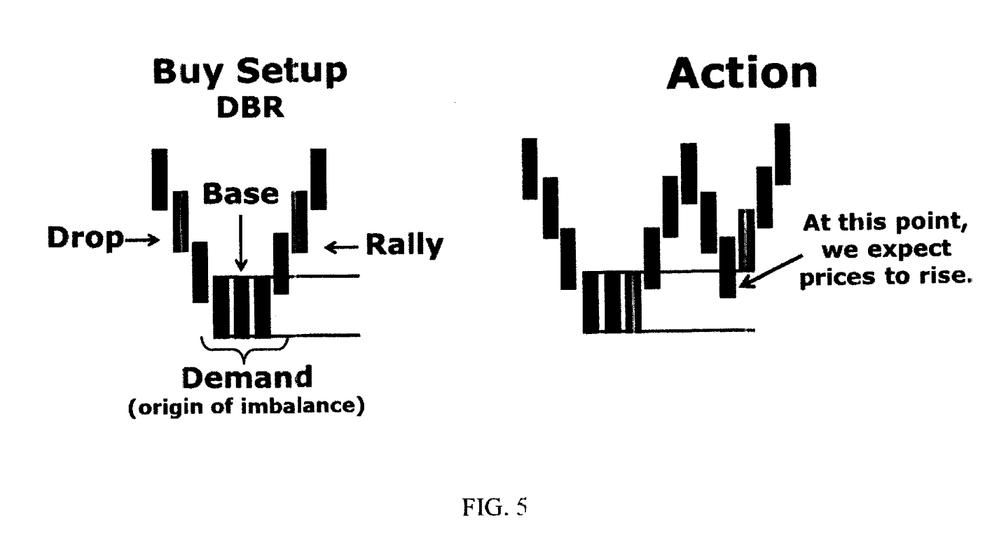

FIG. 5 illustrates an example of a Demand Buy set-up as such might be detected by buy setup engine 220 according to a preferred embodiment. It will be understood and acknowledged by one of skill in the art that these specific market conditions are not exhaustive for when a buy set-up would occur. Further, the specific pattern detected is only one example of a setup which could be detected and exploited by the system of the present invention and the present invention is therefore not limited thereto. With reference to FIG. 5, an exemplary buy set-up which is referred to as a “drop-base-rally” set-up is illustrated. In this case, there are a series of candles in the downward direction (drop), followed next by a demand condition (base) which demonstrates that the instrument is in a market condition at which demand is equal to supply, followed by higher prices for the instrument (rally) identifying the origin of market imbalance where demand exceeds supply. These market conditions are detected by buy setup engine 220 during the start of the rally phase of the setup and as such, trade signal generator 290 generates a buy signal which can be acted upon when price returns back to the demand zone where the system determines that demand exceeds supply.

The action which should be taken in the case where a drop-base-rally is identified by buy setup engine 220 is illustrated in the right chart in FIG. 5. The drop-base-rally setup identifies the demand zone which serves as the entry zone for placing a buy order at the origin of the rally phase. The buy transaction (order) is executed when price revisits the identified demand zone. (a “buy retracement” as illustrated in the right chart). This market condition and its effects are explained in greater detail below. However, it is important to note, as is shown in FIG. 5, that notwithstanding this retracement, it is expected that prices will continue to rise given the out of balance supply and demand relationship as had been previously identified.

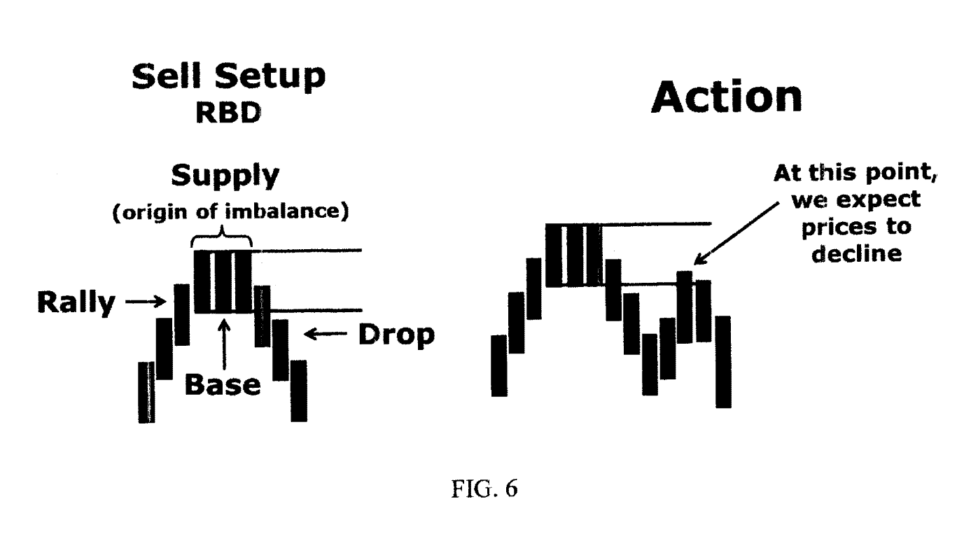

Turning now to FIG. 6, a similar discussion is provided with respect to a Supply Sell set-up which may be detected by sell setup engine 230 and provided by Supply and Demand Trading Subsystem 100 to TOPS 600 as a potentially available trade. Once again, it will be understood and acknowledged by one of skill in the art that these specific market conditions are not exhaustive for when a sell set-up would occur. Further, the specific pattern detected is only one example of a setup which could be detected and exploited by the system of the present invention and the present invention is therefore not limited thereto. With reference to FIG. 6, an exemplary sell set-up which is referred to as a “rally-base-drop” set-up is illustrated. In this case, there are a series of candles in the upward direction (rally), followed next by a supply condition (base) which demonstrates that the instrument is in a market condition at which supply is equal to demand, followed by lower prices for the instrument (drop) identifying the origin of a market imbalance where supply exceeds demand. These market conditions are detected by sell setup engine 230 during the start of the drop phase of the setup and as such, trade signal generator 290 generates a sell signal which can be provided by Supply and Demand Trading Subsystem 100 to TOPS 600 as a potentially available trade when price returns back to the supply zone where the system determines that supply exceeds demand.

The action which should be taken in the case where a rally-base-drop is identified by sell setup engine 230 is illustrated in the right chart in FIG. 6. The rally-base-drop setup identifies the supply zone which serves as the entry zone for a potential short sell order at the origin of the drop phase. The sell transaction (order) is suggested when price revisits the identified supply zone (a “sell retracement” as illustrated in the right chart). This market condition and its effects are explained in greater detail below. However, it is important to note, as is shown in FIG. 6, that notwithstanding this retracement, it is expected that prices will continue to drop given the out of balance supply and demand relationship as had been previously identified.

Now that various examples of trading patterns for buy and sell setups have been described, the following discussion provides further details concerning how these set ups are employed by the Supply and Demand Trading Subsystem 100 to generate potential trading opportunities which are fed to TOPS 600. In particular, signals are largely based, as described above, on detecting a series of price points for an underlying instrument in which the price level represents an out of balance supply and demand condition. These price points are identified as being in “supply zones” and “demand zones”. A detailed description of how these supply and demand zones are determined by supply zone generator 250 and demand zone generator 260 of the present invention, in preferred embodiments thereof, now follows.

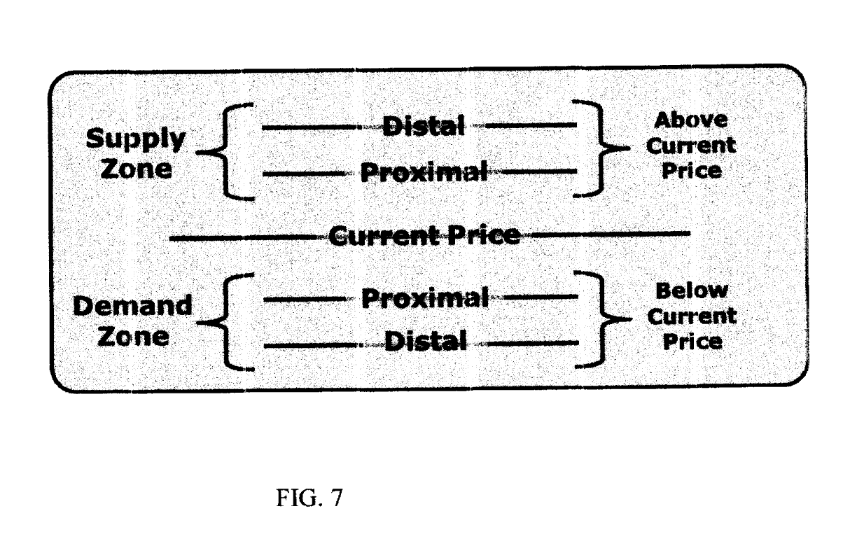

Referring now to FIG. 7, each of the supply and demand zones are now discussed including where they fall on the price chart according to the teachings of the present invention. It its most basic sense, the supply and demand zones represent price ranges in which supply and demand for an underlying instrument is out of balance. In other words, it is believed that when an instrument's price falls within these zones that, in the case of a supply zone, supply exceeds demand and in the case of a demand zone, demand exceeds supply. According to the teachings of the present invention, when the price of an instrument trades within these zones, and given the expected future price movement, conditions are optimal for a sell or buy trade.

The supply zone is located above the current price of the underlying instrument and is comprised of two horizontal lines as they would appear on a price chart. The horizontal line which is at the lower price point and is closest to the current price is referred to as the proximal line and the higher price point line which is furthest away from the current price is referred to as the distal line. The price points within the range created by proximal and distal lines represent price points within the supply zone. With respect to the demand zone, the two lines are the proximal line which is closest to the current price (but below it) and at the higher price point and the distal line which is furthest from the current price and at the lower price point. The price points within this range represent price points within the demand zone.

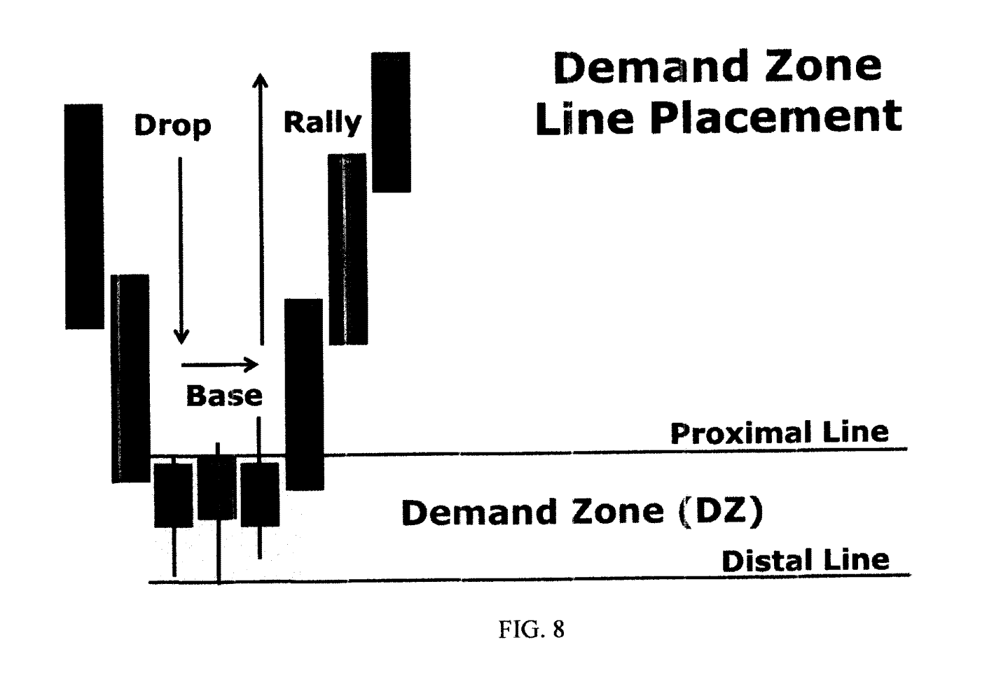

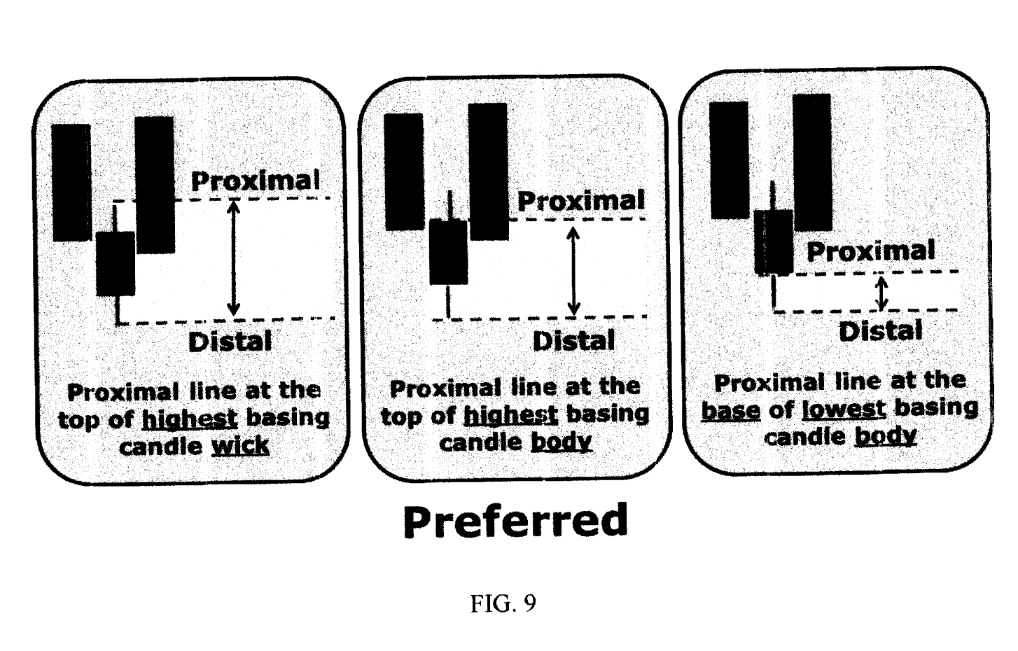

Turning now to FIGS. 8 and 9, the process for determining the demand zone according to the various preferred embodiments of the present invention is now described. In particular, demand zone generator 260 processes market data to determine the demand zone for a particular tradable instrument. In a preferred embodiment of the present invention, this processing as well as the reporting via generation of trade signals by trade signal generator 290 happens in real time or as close to real time as possible so that the trading signals can be most effectively provided to TOPS 600 in a way that enhances the chances for profitable trading. As discussed in further detail below, an alternative is something less than real time trading signal generation which is feasible when a selected trading horizon is of a longer term such as with swing trading and/or longer term wealth generation strategies.

The description of the determination of the demand zone including the placement of both the proximal and distal lines setting the boundaries thereof, is best understood through a discussion of an example of price movement in an instrument which is illustrated via a series of candles. It is presumed that one of skill in the art is well versed in the construction and use of Japanese candlestick charts, however a basic overview of the key aspects is now provided for convenience. With reference to FIG. 8, a series of candles are presented which reflect the instrument's pricing over a particular set of time periods. For example, each candle may represent a time period of one minute, with the chart showing a price movement over a series of one minute periods (each represented by a single candle) for a total of eight minutes given the example of eight successive candles in FIG. 8. Typically candles are made up of the body and the wicks. In this case, wicks are only shown for the third, fourth and fifth candles in time sequence.

The bodies (rectangular portion) represent the range of the opening and closing price, with the top of the body showing the open (if the instrument's price went down over the course of the relevant time period) and the bottom of the body showing the close (again, assuming the instrument's price went down over the course of the relevant time period. Alternatively, if the instrument's price increased over the course of the relevant time period, the top of the body will be the closing price for the time period and the bottom of the body will be the opening price for the time period. The wicks, which extend out from the body, reflect the range over the whole trading period with the top of the top wick representing the high price achieved for the time period and the bottom of the bottom wick representing the low price achieved for the time period. In one preferred embodiment of the present invention, the relevant time periods are very short, usually a minute or less so that rapid trades based on fast moving markets can be effectively made. Notwithstanding the foregoing, one unique advantage of the present invention is that it is designed to work regardless of the time period. Time periods ranging from a very short time (usually a minute or less) for rapid trading to longer time periods (usually daily and weekly candles) for swing and position trading and investing may be used while remaining within the scope and spirit of the present invention.

With that understanding and again referring to FIG. 8, the drop-base-rally chart pattern is shown. Darker candles illustrate downward price movement during the relevant period (assume, for example, one minute intervals). Therefore the first two candles show two successive one minute periods where the price of the instrument was dropping (meaning that the opening price for each of these periods is at the top of the body and the closing price for that period is at the bottom of the body). Then, the third, fourth and fifth candles show a basing condition with the third and fifth candles showing smaller downward price movement during the period and the fourth candle showing a small upward price movement during the period. Next, the rally is illustrated by candles 6, 7 and 8 which each reflect a significantly higher price at the end of the period as compared to the beginning of the period based on the lighter grey shading of the candle body.

According to a preferred embodiment of the present invention, the proximal line of the demand zone is drawn at the top of the basing candle bodies and the distal line is drawn at the bottom of the basing candle wicks. This is shown in FIG. 8 such that the proximal line is drawn at the top of the body of the fourth candle body and the distal line is drawn at the bottom of the bottom wick of the fourth candle body. This is the preferred methodology for generating the demand zone. However, FIG. 9 shows both this preferred methodology as well as alternate methodologies which may alternatively be used. In FIG. 9, the middle chart shows the preferred methodology while the left chart shows the placement of the proximal line at the top of the highest basing candle wick and the right chart shows placement of the proximal line at the base of the lowest basing candle body. In all cases, it is preferred that the distal line is located at the bottom of the bottom wick of the lowest basing candle. Of course, as will be readily apparent to one of skill in the art, these and other rules for placement of the proximal and distal lines, which in turn define the demand zone, may also be used without departing from the scope and spirit of the present invention.

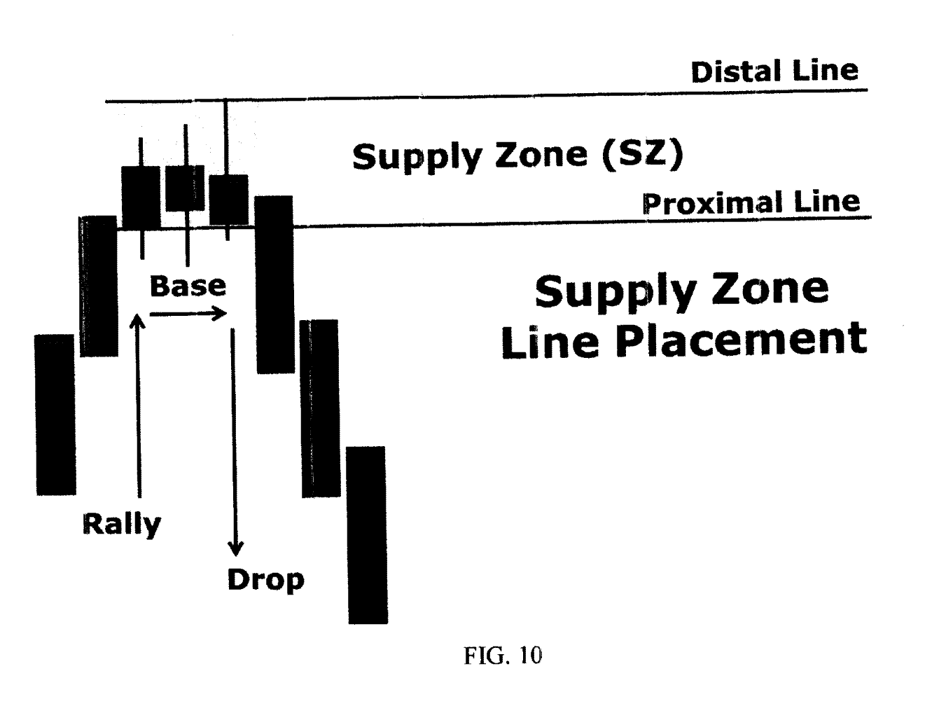

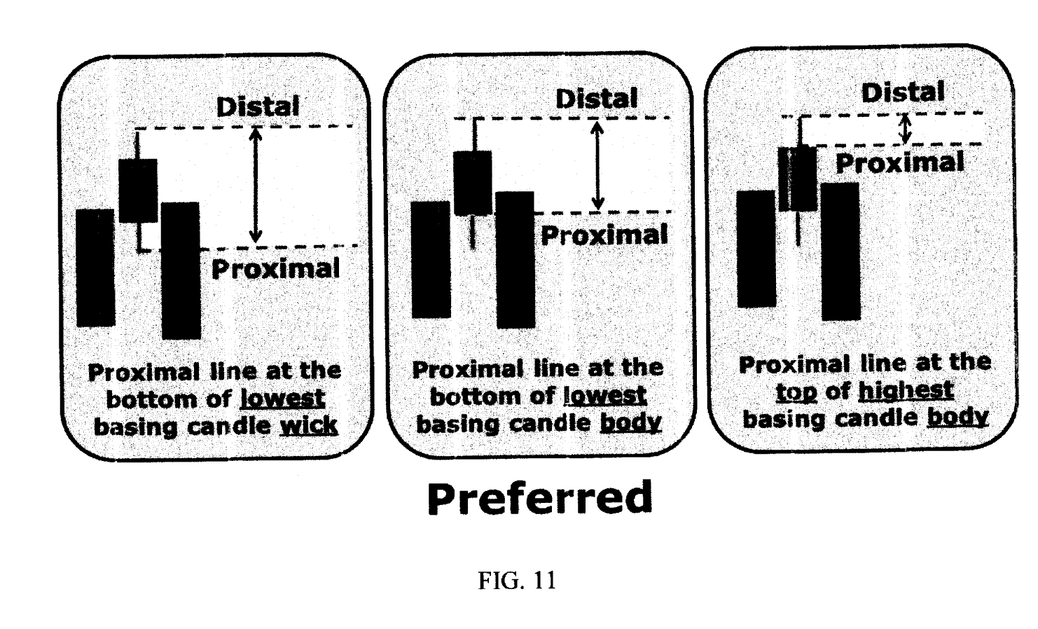

The determination of the supply zone according to a preferred embodiment of the present invention is similar to that which was just described for the determination of the demand zone. With reference to FIGS. 10 and 11, this process is now described. Supply zone generator 250 generates the supply zone including the proximal and distal lines in much the same way as described with respect to the demand zone. In this case, the rally-base-drop pattern is identified by sell setup engine 230 and using the exemplary price pattern of FIG. 10, the basing candles (3^{rd}, 4^{th} and 5^{th}) are used to determine the distal and proximal lines for the supply zone, which as discussed above, determines where sell signals for potential trades are generated by trade signal generator 290.

With reference to FIG. 11, in the supply zone case, the proximal line is located at the bottom of the lowest basing candle body in a preferred embodiment of the present invention. Alternately, the proximal line may be located at the bottom of the lowest basing candle wick (left diagram) or at the top of the highest basing candle body (right diagram). With proximal and distal line placement, there are two primary principals at work. The size of the zone and the placement of the proximal line in relationship to the base of the zone. With respect to zone size, the bigger the zone, the better chance the order will meet entry and the trade will be executed, but also the greater amount of risk taken on. The smaller the zone, the lower the chances of order execution but the risk is minimal as well. With respect to proximal line placement, the closer the proximal line is placed to the current price, the better chance the order will be filled, but the potential profit margin is diminished. In all cases, it is preferable that the distal line be located at the top of the top wick of the highest basing candle body.

According to a preferred embodiment of the present invention, trades are triggered with respect to supply and demand zones according to one of three models. Other models are also possible. In a first model, known as a “limit entry”, a sell limit order for a sell entry is placed just above the proximal line of the supply zone with a buy stop order also being placed just above the distal line. Similarly, a buy limit order is placed at the point just below the proximal line with a stop loss sell order also being placed just below the distal line of the demand zone.

A second model is known as a “zone entry”. In this case, as sell limit or market order is placed when the price occurs anywhere within the supply zone. Again, it is preferably to also place a buy stop order just above the distal line of the supply zone. A limit or market sell short order may also or alternatively be placed when the price occurs anywhere inside the supply zone. With respect to the demand zone, a limit or market buy order is placed when the price occurs anywhere within the demand zone.

A third model is known as a “confirmation entry”. In this case, a sell short order is placed when the price rallies into the supply zone first and is shorted when the price crosses below the proximal line of the supply zone. Further, a buy order is placed when the price drops into the demand zone first and the instrument is purchased when the price crosses above the proximal line.

According to these models, the limit entry has the following advantages:

1) Probability of meeting entry is the highest

2) It is typically a set and forget strategy

and suffers from the following disadvantages:

1) Higher risk than zone entry

2) Lower reward than zone entry

3) Greatest unknown, increasing chance of stopping out

The zone entry has the following advantages:

1) Risk is the lowest of entry types

2) Reward is greatest of entry types

3) Probability of meeting entry is higher than confirmation entry

and suffers from the following disadvantages:

1) Lower probability of meeting entry

2) Typically requires manual entry

The confirmation entry has the following advantages:

1) Risk is the same as limit entry

2) Reward is the same as limit entry

3) Less chance of stopping out

and suffers from the following disadvantages:

1) Lowest probability of meeting entry

2) Typically requires manual entry

As will be apparent to one of ordinary skill in the art, the above three models are merely exemplary as possible models for trade entry and exits and other models are possible while remaining within the scope and spirit of the present invention.

Another novel aspect of the present invention is the “market screener” functionality of TOPS 600. This functionality is preferably implemented such that Supply and Demand Trading Subsystem 100 scans for potential trades and presents them to a user operating at user terminal 690. The set of potential trades are purposely limited in two ways. First, potential trades are sourced only from those that meet the supply and demand trading strategies discussed above and as implemented by Supply and Demand Trading Subsystem 100. Second, potential trades are limited such that only those meeting the criteria/filters desired by a user and/or an administrator or both are presented to the user.

With respect to this second limitation, in one embodiment, all filtering/screening criteria can be set by a system administrator which, in practice might be an employee of a trading service implementing the system and methodologies of the present invention. So, for example, that employee, based on the targeted strategies of the trading service, might set filters such that only trades involving US stocks with trading volumes of over 1 million shares per day and with P/E ratios of under 30 are considered. As such, only stocks with those fundamental characteristics will be considered initially and only the trading patterns for those stocks will be monitored by Supply and Demand Trading System 100 as directed via configuration engine 640 of TOPS 600. This same set of criteria and/or a practically unlimited set of other criteria/filters could alternatively be set by a user via user terminal 690. It is also possible that criteria and filters may be set by both of an administrator and a user.

In some embodiments, an administrator might set the available criteria for users to select from with the users making the actual selections. So, for example, an administrator might set available criteria as:

A) SELECT INSTRUMENT—STOCKS ONLY, BONDS ONLY, CURRENCIES ONLY, STOCKS AND BONDS ONLY, STOCKS AND CURRENCIES ONLY, ETC.

B) SELECT PER UNIT PRICE RANGE—1-9, 10-15, 16-19, 20-30, ABOVE 30, ETC.

C) SELECT INDUSTRY (STOCKS ONLY)—TELECOMMUNICATIONS, MINING AND MINERALS, FINANCIALS, UTILITIES, ETC.

A user may then make selections as permitted by the system as directed by the administrator and scanning will only occur with respect to tradable instruments meeting the desired criteria. As will be readily recognizable by one of skill in the art, the above are merely exemplary and practically any criteria/filter could be used in connection with the present invention in order to set the desired universe of trading instruments scanned for possible trading opportunities.

In another aspect of the present invention, a user and/or administrator may select a trading horizon from among a set of available trading horizon. By way of example, the system of the present invention may provide for three trading horizons such as:

1) Short Term/Real-time/Day Trade/Income

2) Medium Term/Weekly/Swing Trade

3) Long Term/Wealth Creation/Monthly and Longer

Again, the above are merely exemplary and many different sets of time horizons could be implemented while still remaining within the scope and spirit of the present invention.

Through the selection of a time horizon using TOPS 600, a number of results occur. First, based on a notification to Supply and Demand Trading Subsystem 100 by configuration engine 640 of a specific time horizon desired, Supply and Demand Trading Subsystem 100 may apply only certain trading strategies in generating potential trades. These may include, for example, only medium term supply and demand strategies if the same are selected by a user and as discussed above with respect to the operation of Supply and Demand Trading Subsystem 100. In addition, this may affect the frequency and timing of scans and reporting of trading opportunities by Supply and Demand Trading Subsystem 100 to TOPS 600 for presentation to the user by presentation control 650. For instance, if a user selects an interest in short term/day trade type strategies, then this will necessarily imply more frequent scans by Supply and Demand Trading Subsystem 100 as well as more frequent updates of potential trades as presented to the user by presentation control 650 of TOPS 600.

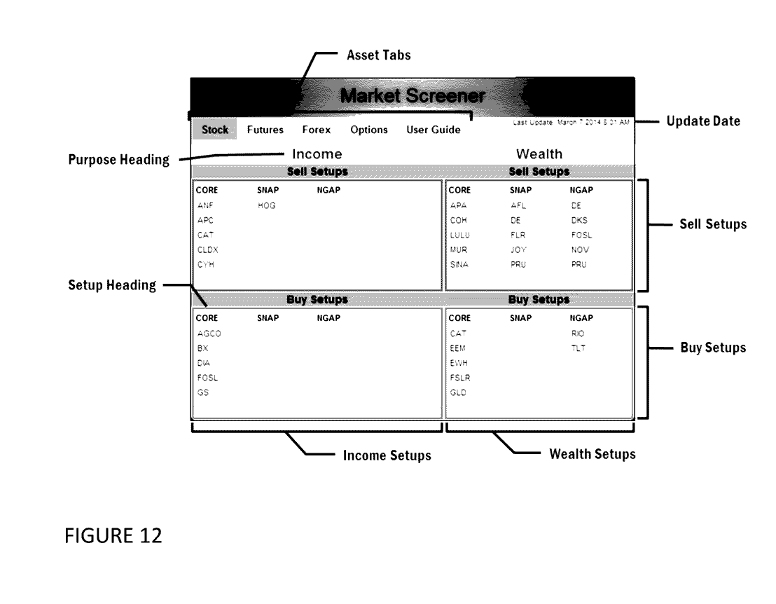

Turning now to FIG. 12, an exemplary user interface whereby a user may view potential trades as generated and displayed by Supply and Demand Trading Subsystem 100 and TOPS 600 of the present invention, is provided. As can be seen from the figure, various windows, tabs and data are displayed for viewing by the user. As will be recognized by one of skill in the art, this presentation format as well as the type of data shown is merely exemplary and various modifications could be made while still remaining within the scope and spirit of the present invention.

The reference to “asset tabs” in the figure illustrates the various categories of tradable instruments that might be viewed and/or selected by a user for potential trades. In this example, the user has selected the “Stock” tab resulting in a view of potential trades for stocks only. As discussed above, various other categories of tradable instruments may be selected such as futures, forex (currencies), and options, as illustrated by the other asset tabs in FIG. 12. The reference to “update date” in the figure illustrates the date and time of the last update for tradable opportunities. This allows the user to assess how current the information is which is important in determining the timeliness of the trading opportunities in connection with decision making. In cases where shorter term trading strategies are employed, the user will expect very recent data as generated by Supply and Demand Trading Subsystem 100 so as to enhance the likelihood of trading success. In some embodiments, the display, including all potential trading opportunity data will be updated automatically on the screen via a web based interface/plug in such as Java™ etc. while in other embodiments the display may be static, requiring a user to manually refresh data which may be implemented by TOPS 600 via a new request for a data scan and the presentation of the updated results to the user.

With respect to the “Purpose Heading” shown in the figure, this may represent the time horizon for trading strategies as discussed above. In this example, display of trading opportunities for both “Income” (shorter term) and “Wealth” (longer term) may be displayed so that a user may select among various opportunities for each of these time horizons. Thus, the leftmost trading opportunities in FIG. 12 are shorter term opportunities while those in the right column represent longer term trading opportunities. Again, following the present example, both “sell setups” and “buy setups” for each of “Income” and “Wealth” time horizons are presented. As discussed above, the buy setups are selected when it is intended for a user to purchase the tradable instrument, while a “sell setup” is selected when a user is intended to sell or “sell short” a tradable instrument.

A “Setup” is a group of conditions that provide a nuance for ways that the Supply and Demand Strategy react to market conditions. Within each of the setup boxes in the figure, there are three defined Setups shown as “Setup Heading”—“CORE”, “SNAP” and “NGAP”. These represent the specific trading Setups as implemented by Supply and Demand Trading Subsystem 100 in generating the potential trading opportunities. The “CORE” trading Setup represents the supply and demand trading strategy described above with respect to the operation of Supply and Demand Trading Subsystem 100. The other two trading Setups represent other potential trading Setups that could be implemented by Supply and Demand Trading Subsystem 100 or by another subsystem implementing the applicable trading strategy and interfacing with TOPS 600 for display of generated potential trades to users.

Returning to the example in FIG. 12, the display, for example, shows a number of CORE trades available as buy setups for an “Income” strategy. This is reflected in the bottom left quadrant of the display. In this case, each of stocks ACCO, BX, DIA, FOSL and GS have current buy setups that may reflect a potential purchase of such stocks by a user at the current time. The window is also scrollable indicating that other stocks are also currently available as a potential buy trade for an income based strategy if the user were to scroll down the list to reveal the remaining available potential trades. As will be apparent, other available trades illustrated in the display include, for example, a number of sell setups in a wealth strategy for each of the three trading strategies (CORE, SNAP and NGAP) (upper right quadrant) as well as sell setup/income trades for the CORE and SNAP strategies (upper left quadrant). Finally, buy setup/wealth trades are available for the CORE and NGAP strategies (lower right quadrant).

According to one embodiment of the present invention, and according to the example in FIG. 12, a user at user terminal 650 could select a stock (e.g. DIA in the lower right quadrant) representing a potential trade and click on that stock for additional information regarding the stock and the potential trade as well as the ability to interface with a trading platform to initiate the recommended trade. For example, the user might click on DIA which could bring up a window showing, for example, the current price of DIA, the Setup associated with the potential trade as well as other relevant information. The window may also include either a link to a new window for executing a trade or a button or set of buttons and data entry fields for initiating a trade as is known in the art.

By way of example, a user may select DIA for current purchase using the CORE Setup as applied to an income timing horizon. In this case, the intention is for the user to buy from a market participant such that the user has a strategic advantage in the trade as against the other market participant. According to the teaching herein, that other market participant/seller is making three key mistakes by selling to the user at the designated time. The user is buying from a seller who is selling AFTER a decline in price, INTO a Demand Zone and DURING an Uptrend. The odds are thus stacked against the seller in this case meaning they are stacked in favor of the user of the system of the present invention.

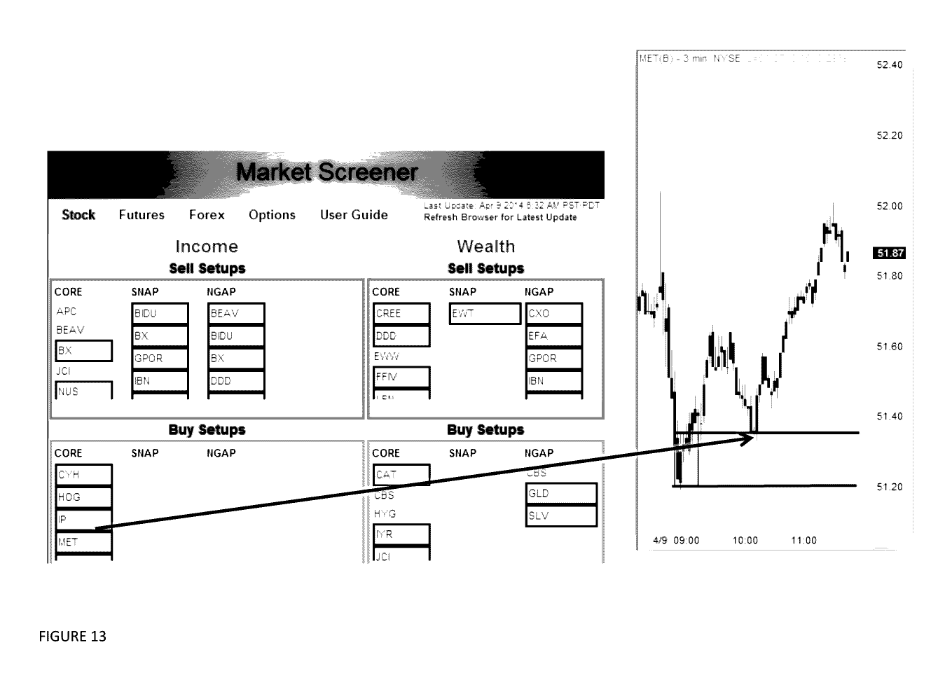

Turning now to FIG. 13, another view of an exemplary graphical user interface is presented along with an illustrative price vs. time chart for one of the stocks recommended for trade. In this example, a buy setup is presented for stock MET as a potential trade for the CORE strategy on an “Income” time horizon. The chart to the right shows a fresh demand zone occurring for the stock at the time of the recommendation. This is the basis behind the trading opportunity generated by Supply and Demand Trading Subsystem 100 as displayed on user terminal 690 through the operation of TOPS 600 and in particular presentation control 650. A user may elect to act on the trading opportunity as discussed above through the operation of and interaction with the execution control component 660 of TOPS 600.

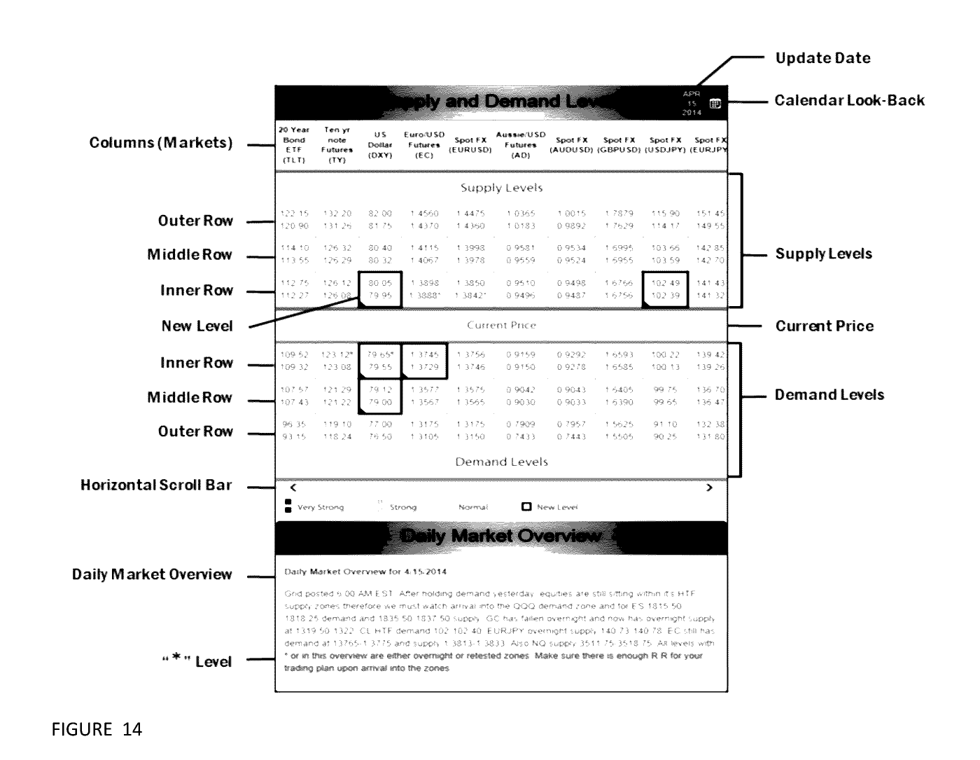

With reference now to FIG. 14, a view of an alternative presentation on the user interface for user terminal 690 is provided and now discussed. This presentation may be provided, according to the teachings of the present invention, as an alternative to the graphical user interface shown in FIGS. 12 and 13. As discussed above and as will be readily understood by one of skill in the art, many other formats and display content combinations are also possible while still remaining within the scope and spirit of the present invention. In this case, presentation control 650 may generate a grid like display as shown in FIG. 14 such that the user can select between and among various trading opportunities generated by Supply and Demand Trading Subsystem 100 using, in this case, the CORE Setup.

As can be seen in the figure, various supply and demand levels are shown along with an update date and time so that a user may ascertain the timeliness of the data. Again, these supply and demand levels, as shown in the figure, may apply to one or more trading time horizons such that the potential trades generated by Supply and Demand Trading Subsystem 100 may be eliminated and/or modified depending on the trading time horizon selected by the user and/or by an administrator. So, for example, a trade generated by Supply and Demand Trading Subsystem 100 that would otherwise be included in the display as a potential trade for a wealth based/long time horizon strategy or a medium term strategy, might be removed from the display if the user or administrator desires only a short term/day trading horizon.

The columns in the grid in this example represent individual trading instruments for different categories of markets. So, for example, the 30 year bond (as represented by the TLT exchange traded fund) forms the first column. Other instruments such as the ten year note future, the US dollar currency, and various spot FX currency vehicles are also represented. As noted above, this is merely an example and columns could potentially also include individual stocks, individual bonds, options and/or any other tradable instrument. A horizontal scroll bar allows for the addition of additional columns representing additional instruments that can be scanned, analyzed and for which the relevant data associated with each instrument can be displayed.

A description of the data displayed, in one preferred embodiment of the present invention is now provided. Viewing each of the rows, there is a current price level row for each instrument which is indicative of where the current instrument price currently stands without actually displaying the current price. In some embodiments, the actual current price for some or all instruments could be displayed in this row. For all rows above this central row, supply levels are indicated in which the instrument is trading at a high or higher supply level and for all rows below this central row, demand levels are indicated in which the instrument would be trading at low or lower demand levels. These levels can be generated by Supply and Demand Trading System 100 and controlled for display in via TOPS 600 so that additional trading decisions can be made based on this available data. In addition, a manually written “daily market overview” and/or some other or additional market commentary may also be provided. The calendar look-back button at the upper right corner allows users to assess supply and demand levels at earlier dates for comparison purposes if desired.

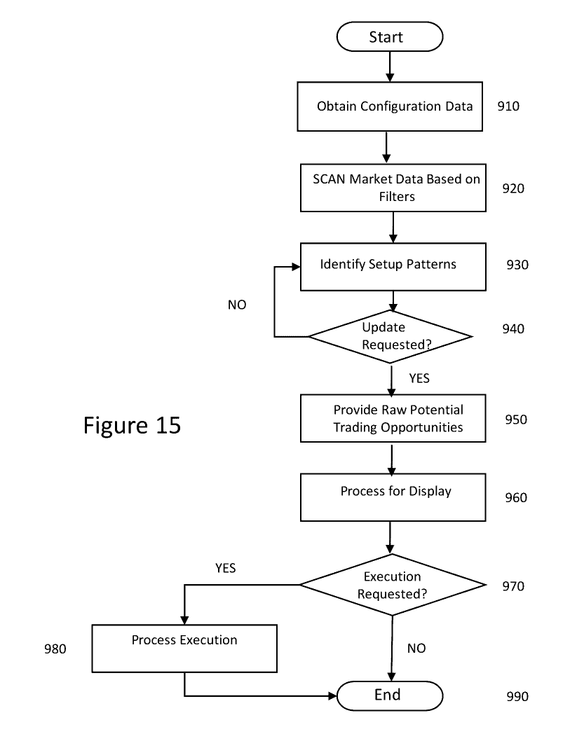

With reference now to FIG. 15, a discussion of the high level steps undertaken by Supply and Demand Trading Subsystem 100 and TOPS 600 in connection with monitoring markets and providing automated presentation of potential trading opportunities desired by users according to their criteria and filters, in a preferred embodiment thereof, is now provided. At step 910, TOPS 600 obtain configuration data via prompts from configuration engine 640 and responsive input from users and administrators. This configuration data, as discussed above, may include desired frequency of updates for potential trades, stocks/markets/instrument categories to be scanned, trading time horizon, fundamental and technical data associated with tradable instruments as well as other data as desired.

This information is then used by Supply and Demand Trading Subsystem 100 at step 920 to scan market data for potential trading opportunities based on the trading system itself (e.g. the CORE Setup described above), the filters specified by users and administrators and other information. As these market and instruments are scanned for potential trades based on market movement of the relevant instruments, one or more setup patterns for one or more tradable instruments may be identified at step 930. Once a setup pattern for a particular instrument is identified by either buy setup engine 220 or sell setup engine 230, either demand zone generator 260 or supply zone generator 250, respectively, will next generate a demand zone or supply zone, respectively, representing the price range at which the trading opportunity exists as described above. Once the market data indicates that price level for the specific instrument is within the supply zone or demand zone as described above, a potential trade with respect to a particular tradable instrument is identified by trade signal generator 290.

At step 940 and based upon selected update frequency and/or a manual request for a refresh of data by a user, Supply and Demand Trading Subsystem 100 may be commanded periodically to provide all available trading opportunities meeting specified criteria to TOPS 600 for further processing by TOPS 600. In the meantime, when not commanded for an update, processing returns to step 930 where setup patterns and potential trades continue to be monitored.

When it is time to provide an update, raw potential trade data is supplied by Supply and Demand Trading Subsystem 100 to TOPS 600 at step 950. At step 960, presentation control component 650 of TOPS 600 processes the raw potential trade data for display for the user at user terminal 690 via a selected graphical user interface.

As discussed above, step 960 may also include providing one or more notifications to a user regarding potential trading opportunities including via SMS text, via email, via web based messaging and other methodologies. Notifications may be generated on a periodic basis and/or based on other criteria selected by a user and/or an administrator. For example, a user may be notified only when setups exist for a specific stock, only when a very high demand or supply level exists for an instrument above a set threshold, only for buy setups or only for sell setups or for any other type of criteria as may be selected by a user.

As noted above, in some cases, a user may be permitted to invoke trade executions for one or more potential trading opportunities directly from the potential trade graphical user interface. In this case, at step 970, if an execution is requested for one or more trade opportunities, then such trade(s) are executed at step 980 and then the process ends at step 990. Alternatively, if no execution is desired and/or that capability does not exist in the system as implemented, then the process proceed directly to step 990 and ends there.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A supply and demand based trading system configured to present actionable trading signals, the supply and demand based trading system comprising:
one or more processors configured to execute computer program modules, the computer program modules comprising:
a market data receiving module configured to receive pricing data for at least one instrument;
at least one set up engine module configured to detect setup occurrences with respect to said at least one instrument;
at least one zone generation module configured to generate at least one pricing zone relative to said setup occurrences; and
a trade signal generation module configured to generate a trading signal as a result of said instrument price obtaining a defined value relationship with respect to said at least one pricing zone.

2. The system of claim 1 wherein said pricing data comprises real time pricing data.

3. The system of claim 1 wherein said at least one pricing zone comprises a supply zone.

4. The system of claim 1 wherein said at least one pricing zone comprises a demand zone.

5. The system of claim 1 further comprising an execution control module configured to enable a user to execute a trade based upon said generated trading signal.

6. The system of claim 1 further comprising a configuration module configured to permit a user to select one or more characteristics required to qualify said at least one instrument for trading consideration.

7. The system of claim 1 wherein said trade signal generation module is configured to notify a user of said trade signal via email.

8. The system of claim 1 wherein said trade signal generation module is configured to notify a user of said trade signal via text.

9. The system of claim 1 wherein said obtaining a defined value relationship with respect to said at least one pricing zone comprises a limit entry trigger.

10. The system of claim 1 wherein said obtaining a defined value relationship with respect to said at least one pricing zone comprises a zone entry trigger.

11. The system of claim 1 wherein said obtaining a defined value relationship with respect to said at least one pricing zone comprises a confirmation entry trigger.

12. The system of claim 1 further comprising a position size module configured to provide a recommended position size in connection with said generated trading signal.

13. A computer-implemented method of providing actionable trading signals, the method being implemented in a computer system comprising one or more processors configured to execute computer program modules, the method comprising the steps of:
receiving pricing data for at least one instrument;
detecting setup occurrences with respect to said at least one instrument;
generating at least one pricing zone relative to said setup occurrences; and
generating a trading signal as a result of said instrument price obtaining a defined value relationship with respect to said at least one pricing zone.

14. The method of claim 13 wherein said pricing data comprises real time pricing data.

15. The method of claim 13 wherein said at least one pricing zone comprises a supply zone.

16. The method of claim 13 wherein said at least one pricing zone comprises a demand zone.

17. The method of claim 13 further comprising the step of enabling a user to execute a trade based upon said generated trading signal.

18. The method of claim 13 further comprising the step of permitting a user to select one or more characteristics required to qualify said at least one instrument for trading consideration.

19. The method of claim 13 further comprising the step of notifying a user of said trade signal via email.

20. The method of claim 13 further comprising the step of notifying a user of said trade signal via text.

21. The method of claim 13 wherein said obtaining a defined value relationship with respect to said at least one pricing zone comprises a limit entry trigger.

22. The method of claim 13 wherein said obtaining a defined value relationship with respect to said at least one pricing zone comprises a zone entry trigger.

23. The method of claim 13 wherein said obtaining a defined value relationship with respect to said at least one pricing zone comprises a confirmation entry trigger.

24. The method of claim 13 further the step of recommending a position size in connection with said generated trading signal.
